(19) United States
(12) Patent Application Publication
(10) Pub. No.: US 2019/0017161 A1
(43) Pub. Date: Jan. 17, 2019

(54) FERRITIC NITROCARBURIZED VEHICLE COMPONENT AND METHODS OF MAKING AND USING THE SAME

(71) Applicant: GM Global Technology Operations LLC, Detroit, MI (US)

(72) Inventors: Michael L. Holly, St. Clair Shores, MI (US); Mark T. Riefe, Brighton, MI (US); Matthew A. Robere, Novi, MI (US)

(21) Appl. No.: 15/650,013

(22) Filed: Jul. 14, 2017

(51) Int. Cl. C23C 8/02; F16D 65/10; F16D 65/12; C23C 8/04; C23F 17/00; B60T 1/06

(52) U.S. Cl. CPC C23C 8/02; F16D 65/10; F16D 65/127; C23C 8/04; F16D 2200/0021; B60T 1/065; F16D 2200/0013; F16D 2250/0038; F16D 2200/0017; C23F 17/00

(57) ABSTRACT

A number of variations may include a ferritically nitrocarburized vehicle component comprising a compound zone and a friction surface at an outer edge of the compound zone wherein the friction surface is configured for engagement with a corresponding friction material, and wherein the compound zone comprises a nitride layer comprising epsilion iron nitride, Fe₃N and gamma prime iron nitride Fe₄N.

### TECHNICAL FIELD

The field to which the disclosure generally relates to includes vehicle components and methods of manufacture and use thereof.

### BACKGROUND

Currently some vehicle components may be included in rotors and may undergo ferritic nitrocarburization.

### SUMMARY OF ILLUSTRATIVE VARIATIONS OF THE INVENTION

One variation of the invention shows a product comprising: a ferritically nitrocarburized vehicle component comprising a compound zone and a friction surface at an outer edge of the compound zone wherein the friction surface is configured for engagement with a corresponding friction material, and wherein the compound zone comprises a nitride layer comprising epsilion iron nitride, Fe₃N and gamma prime iron nitride Fe₄N.

Another variation of the invention shows a method comprising: providing a vehicle component; ferritically nitrocarburizing the vehicle component to form a compound zone and a friction surface at an outer edge of the compound zone wherein the friction surface is configured for engagement with a corresponding friction material, and wherein the compound zone comprises a nitride layer comprising epsilion iron nitride, Fe₃N and gamma prime iron nitride Fe₄N.

Other illustrative variations of the invention will become apparent from the detailed description provided hereinafter. It should be understood that the detailed description and specific examples, while disclosing optional variations of the invention, are intended for purposes of illustration only and are not intended to limit the scope of the invention.

### BRIEF DESCRIPTION OF THE DRAWINGS

Select examples of variations of the invention will become more fully understood from the detailed description and the accompanying drawings, wherein:

FIG. 1 is a microphotograph showing the microstructure of a FNC pressure plate according to a number of variations.

FIG. 2 is a diagram showing phase stability in iron under different nitriding potentials and temperatures.

FIG. 3 is a perspective view of a disc brake assembly containing a friction material;

FIG. 4 is a side view of a drum brake assembly containing a friction material;

FIG. 5 is a perspective view of a hat rotational member;

FIG. 6 illustrates a portion of a clutch assembly.

FIG. 7 illustrates a portion of a clutch assembly.

FIG. 8 is a schematic depiction of a sectional view showing the transfer layer on the compound layer in an example of the present disclosure at a microscopic enlargement;

FIG. 9 illustrates a disc brake backplate with brake pads adhered thereto, with the backplate including outwardly extending abutments being free of corrosion according to a number of variations.

FIG. 10 illustrates improved corrosion test results for a FNC backplate compared to a non-FNC plackplate.

FIG. 11 illustrates an FNC backplate having opposing abutment surfaces free of rust according to a number of variations.

### DETAILED DESCRIPTION OF ILLUSTRATIVE VARIATIONS WITHIN THE SCOPE OF THE INVENTION

The following description of the variations is merely illustrative in nature and is in no way intended to limit the invention, its application, or uses.

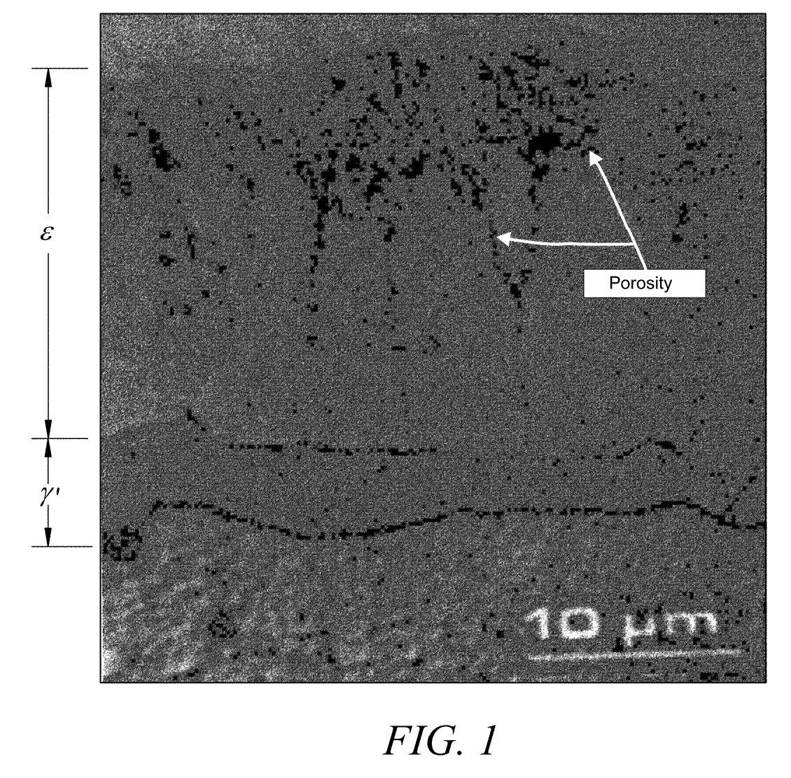

Ferritic Nitrocarburizing (FNC) is a thermochemical diffusion process that introduces nitrogen and carbon into the surface of ferrous materials. FNC processing can be performed in solid, liquid or gaseous media. Typical materials FNC processed include wrought and cast steel, wrought and cast stainless steel, gray iron and nodular iron. Pressure plates are commonly manufactured from wrought steel. FNC processing typically produces a case hardened zone, 3.8-25 micrometers in depth with a commonly specified depth of 10-20 micrometers. The case hardened zone consists of a compound zone or white layer and a diffusion zone. The compound zone typically contains ε carbonitride phase (Fe₂₋₃, (C, N)), some y' nitrides (Fe₄N), cementite (Fe₃C) and various alloy carbides and nitrides. The diffusion zone, underneath the compound zone, consists of dissolved nitrogen and iron nitrides. The compound zone typically improves wear and corrosion resistance. The diffusion zone improves fatigue strength. A reduction in the coefficient of friction is also observed on nitrocarburized parts. The microstructure of the pressure plate is shown in FIG. 1.

FNC processes to introduce nitrogen and carbon into surface include gas, salt bath or fluidized bed media at temperatures less than 590 C. Typical sources for carbon and nitrogen include hydrocarbon gas and ammonia.

Porosity occurs in the compound layers as a result of the metastability of the iron-nitrogen phases, c carbonitride phase (Fe2-3, (C, N)), some y' nitrides (Fe4N). The metastability of the phases will result in decomposition into Fe and N₂(gas). Porosity may be controlled by controlling the amount of nitrogen in the FNC process. Once maximum saturation of nitrogen in the alloy is achieved the nitrogen gas will form porosity in the grain boundary and within the grains. Reducing the process temperature or nitriding potential can reduce the amount of porosity.

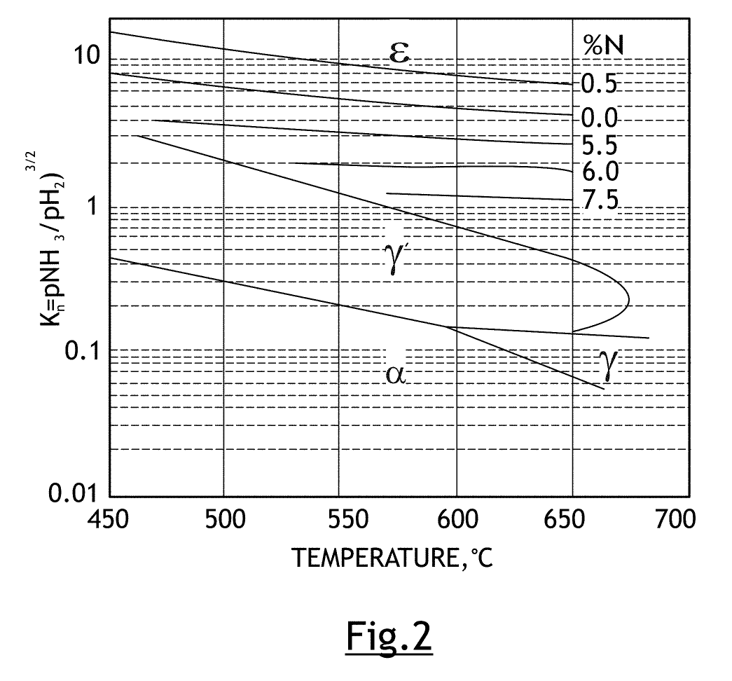

FIG. 2 is Lehrer diagram showing phase stability in iron under different nitriding potentials and temperatures. The Lehrer diagram is useful in setting FNC process parameters.

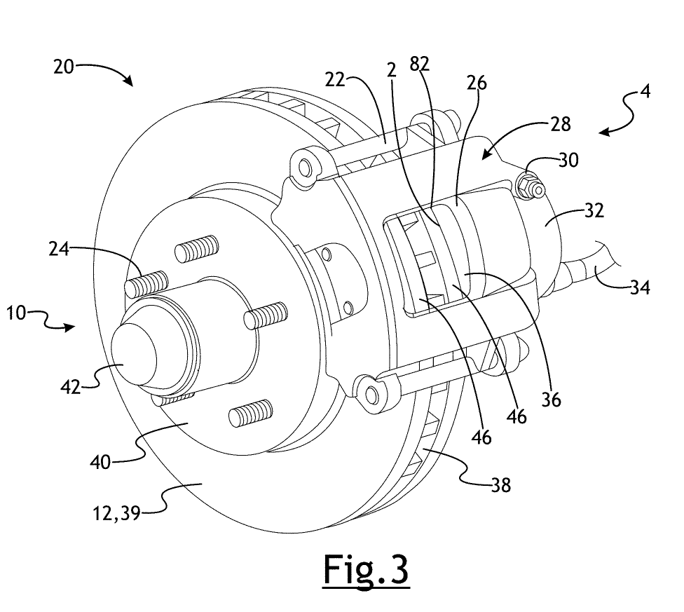

A ferritic nitrocarburized vehicle component 2 is provided in FIGS. 3-7. In a number of variations, the ferritic nitrocarburized vehicle component 2 may be used in a rotation assembly 4 as brake components in a brake 10. A brake 10 may be an energy conversion system used to retard, stop, or hold a vehicle. In some embodiments, a brake 10 may be used to retard, stop, or hold at least one wheel of a wheeled vehicle with respect to a surface. A vehicle brake 10 may be a disc brake 20, drum brake 50, a combination thereof, or may be another type. In a disc brake 20, as shown in FIG. 3, a rotational member 12 may be removably attached to a wheel at a wheel hub 40 and may be known as the brake rotor 39. The brake rotor 39 may include a single annular disc portion or may include two annular disc portions with spaced apart vanes extending therebetween to produce vent slots 38 to improve cooling. When hydraulic fluid may be pressurized in a brake hose 34, a piston inside a piston housing 32 of a caliper 28, causes the caliper 28 to squeeze the brake rotor 39 between brake pads 36. The brake pads 36 may include a ferritic nitrocarburized vehicle component 2 which may comprise or may be coupled to a friction surface 82 that contacts a frictional surface 46 of the brake rotor 39 when the disc brake 20 may be engaged. In a number of variations, the ferritic nitrocarburized vehicle component 2 may be a pressure plate 2 for a brake 10. In a number of variations, the pressure plate 2 may comprise or may be coupled to a friction surface 82. The kinetic energy of the moving vehicle may be converted to heat by friction between the brake pads 36 and the brake rotor 39. Some heat energy may temporarily raise the temperature of the brake rotor 39.

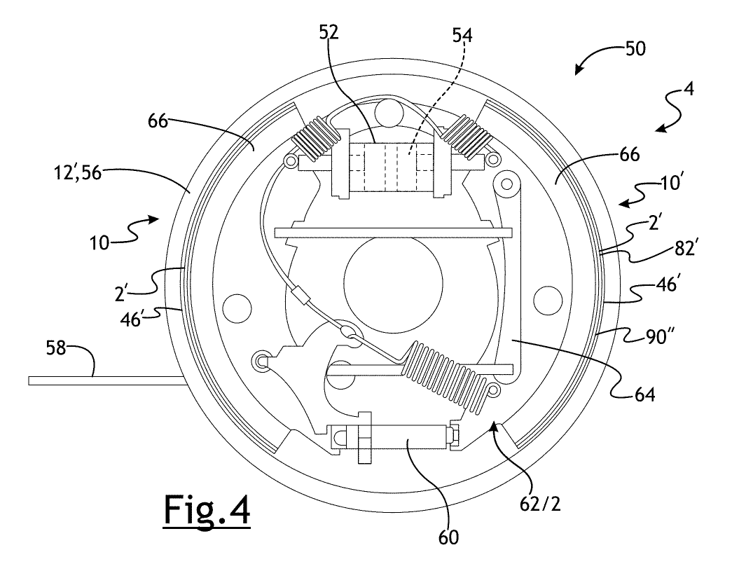

Referring to FIG. 4, a drum brake 50 is shown. The rotational member 12′ may be a brake drum 56. The brake drum 56 may be removably fastened to a wheel and include fins 68 to improve cooling and increase stiffness of the brake drum 50. When hydraulic fluid may be pressurized in a wheel cylinder 52, a piston 54 causes the brake shoe or ferritic nitrocarburized vehicle component 2, which may comprise or be coupled to a friction surface 82′, against a friction surface 46′ of the brake drum 56, causing engagement of the drum brake 50. Alternatively, a drum brake 56 may be engaged mechanically by actuating an emergency brake lever causing the ferritic nitrocarburized vehicle component 2′ to press the friction surface 82′ of the brake drum 56. In a number of variations, the ferritic nitrocarburized vehicle component 2′ may be a brake shoe pressure plate 2′ for a brake 10 and may include a brake lining 66. In a number of variations, the pressure plate 2′ or brake lining 66 may comprise or may be coupled to a friction surface 82′. When engaged, the kinetic energy of the moving vehicle may be converted to heat by friction between the pressure plate 2′ and the brake drum 56. Some heat energy may temporarily raise the temperature of the brake drum 56.

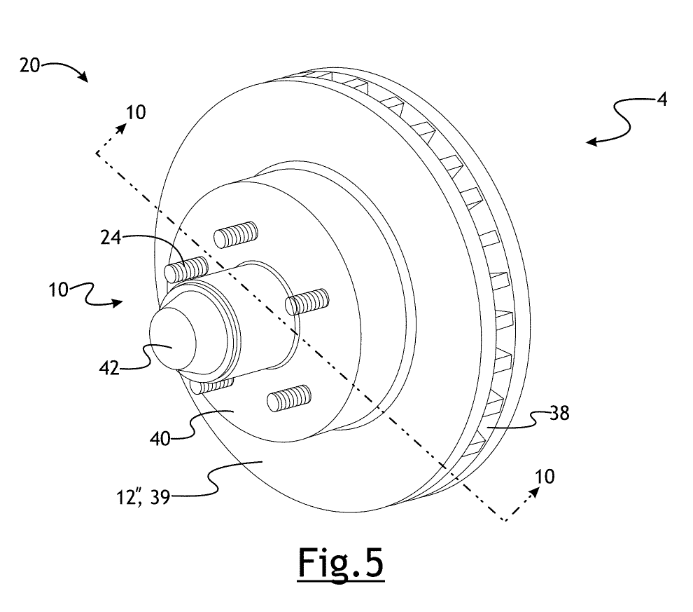

A disc brake 20 may be combined with a drum brake. As shown in FIG. 5, a drum-in-hat rotational member 12″ may be included in combination. In a drum-in-hat brake, small brake shoes may be mechanically/cable actuated as an emergency brake while the flange portion acts as a typical disc brake.

Referring again to FIGS. 3-4, the brake rotational member 12, 12′, 12″ includes a friction surface 46, 46′ that engages the ferritic nitrocarburized vehicle component (pressure plate) 2, 2′ of the brake pad 36 or brake shoe 62 at the friction surface 82, 82′. As the brake 10 may be engaged, mechanical wear and heat may cause a small amount of the friction surface 82, 82′ and the ferritic nitrocarburized vehicle component 2, 2′ to wear away. It may be possible to reduce the rate of wear of the rotational member friction surface 82, 82′ or the ferritic nitrocarburized vehicle component 2, 2′ by reducing the coefficient of friction between the two, but a lower coefficient of friction may make the brake less effective at engagement and retarding, holding, or stopping the vehicle.

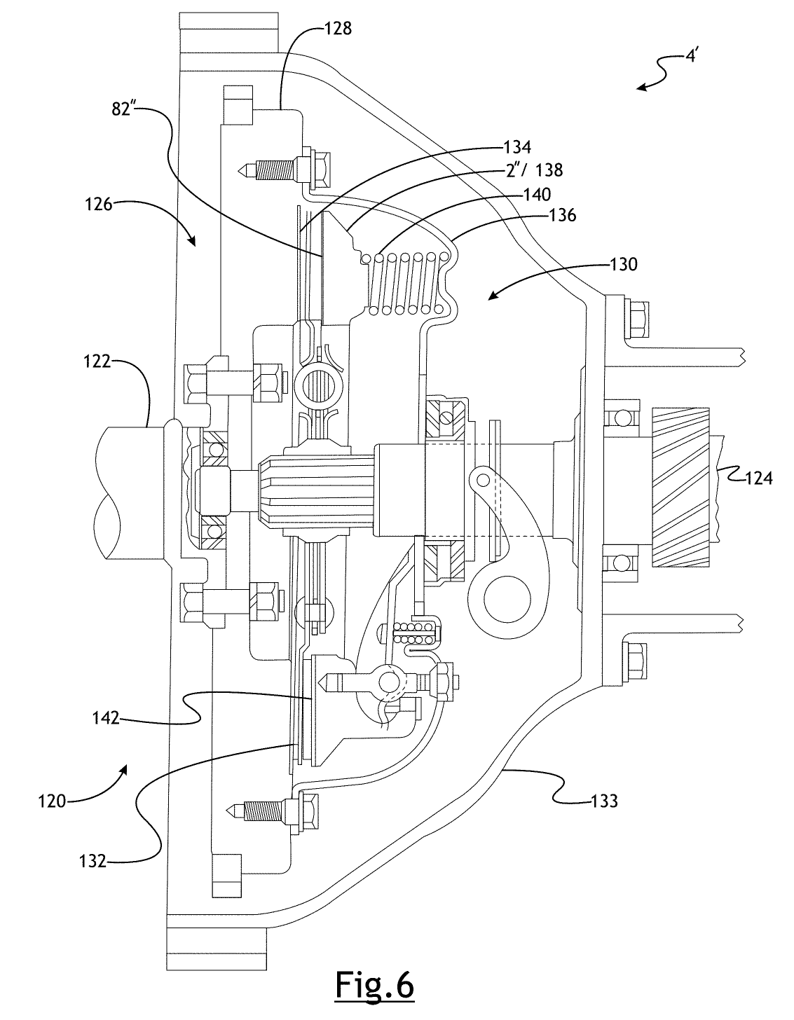

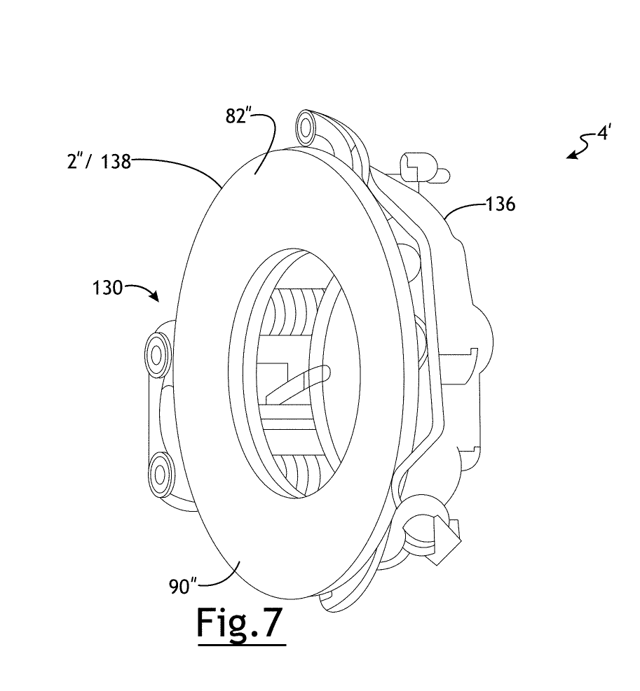

In a number of variations, the ferritic nitrocarburized vehicle component 2 may be used in a rotation assembly 4′ as clutch components in a clutch assembly 120. FIGS. 6-7 illustrate a clutch assembly 120 comprising a nitrocarburized vehicle component 2, according to a number of variations. In a number of variations, the clutch assembly 120 may be rotationally coupled to an engine crankshaft assembly 122, and to a transmission input shaft 124. In a number of variations, the clutch assembly 120 may include a flywheel assembly 126, which may be bolted to and driven by the crankshaft assembly 122. In a number of variations, the clutch assembly 120 may include a pressure plate assembly 130, which may be bolted to and driven by the flywheel assembly 126. In a number of variations, mounted between the flywheel assembly 126 and the pressure plate assembly 130 may be a clutch disc assembly 132. In a number of variations, the clutch disc assembly 132 may be splined to the transmission input shaft 24. In a number of variations the clutch assembly 120 may also include a clutch housing 133 that surrounds the other components and is mounted between the engine (not shown) and the transmission (not shown). In a number of variations, the flywheel assembly 126 may include a flywheel friction member 128. In a number of variations, the flywheel friction member 128 may include flywheel friction member friction surface 134, which may be a very thin layer of steel added on top of the aluminum. In a number of variations, this friction surface 134 may be adjacent to and face the clutch disc assembly 132. In a number of variations, this friction surface 134 may be friction material including at least one of a mild steel, a carbon steel, a stainless steel, or a combination thereof, or a plurality of fibers and particle bound by a resin.

In a number of variations, as shown in FIG. 7, the pressure plate assembly 130 may include a cover 136, which may be bolted to the flywheel assembly 126, and may include a ferritically nitrocarburized vehicle component 2″ or pressure plate friction member 138, which may be mounted adjacent to the clutch disc assembly 132. In a number of variations, the pressure plate friction member 138 may be a nitrocarburized vehicle component 2″. In a number of variations, springs 140 may be mounted between the cover 136 and friction member 138 to bias the friction member 138 away from the cover 136 and into contact with the clutch disc assembly 132. In a number of variations, the friction member 138 may include a friction surface 82″, which may be a very thin layer of mild steel, carbon steel or stainless steel or a combination thereof added on top of the aluminum. In a number of variations, the friction surface 82″ may be coated on the nitrocarburized vehicle component 2″ at locations where the nitrocarburized vehicle component 2″ is adjacent to and faces the clutch disc assembly 132.

In a number of variations, the ferritic nitrocarburized vehicle component in the form of the pressure plate 2 or brake shoe 2′ or clutch pressure plate 2″ may be made of a gray cast iron, stainless steel, steel, or another similar functioning material or polymer and may be ductile. In a number of variations, the steel may be hot rolled or cold rolled. It may be understood that the ferritic nitrocarburized vehicle component 2, 2′, 2″ may be cast, stamped, forged, formed from powdered metal or any suitable forming process. It may be understood that in the production of the ferritic nitrocarburized vehicle component 2, 2′, 2″, graphite flakes may be embedded in the friction surface 82, 82′, 82″. Graphite flakes may account for machinability, wear resistance, damping capacity, low shrinkage characteristics during solidification, and generally higher thermal conductivity during operation. The graphite flakes may be initiation sites for corrosion as they may be dislodged and cause exposure of the friction surfaces 82, 82′, 82″, leading to pitting and roughness. The graphite flakes may also cause corrosion on the corresponding ferritic nitrocarburized vehicle component 2, 2′, 2″. It may be understood that graphite generally has high lubricity when interposed between sliding surfaces. Furthermore, this lubricity may reduce the coefficient of friction between the ferritic nitrocarburized vehicle component 2, 2′, 2″ and the friction surface 82, 82′, 82″ during brake or clutch engagement.

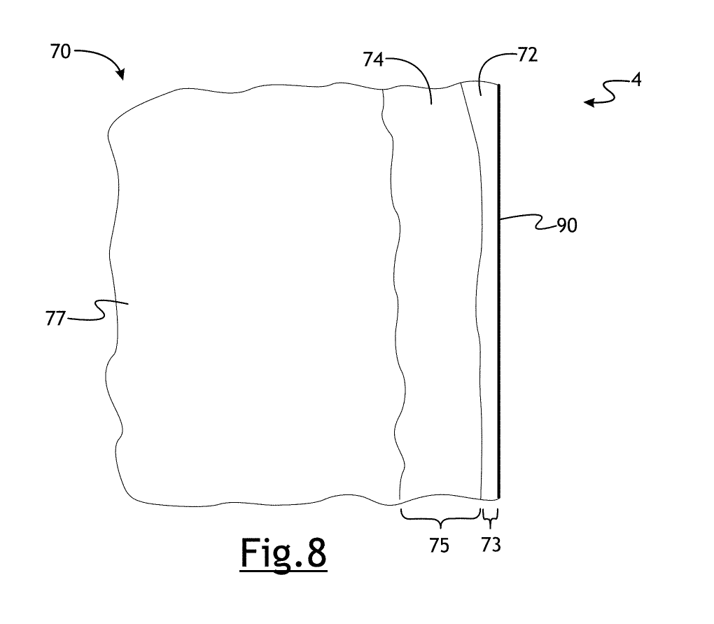

Ferritic nitrocarburization (FNC) has been used to produce the nitrocarburized vehicle components 2, 2′, 2″ and/or the friction surfaces 82, 82′, 82″ that may be case hardened and resistant to corrosion and wear. Ferritic nitrocarburization may be used to dispose a compound zone 70 on the nitrocarburized vehicle components 2, 2′, 2″ and/or the friction surfaces 82, 82′, 82″, as shown in FIG. 8. It may be understood that the rotational member nitrocarburized vehicle components 2, 2′, 2″ does not need to be used in braking, but can be any component in a rotation assembly 4, 4′ (others not shown). Some variations include clutch pack discs, or other components capable of ferritic nitrocarburization. Some variations include axle lockers, or other components capable of ferritic nitrocarburization. In a number of variations, the process may involve nitrocarburization of cast iron or carbon steel ferrous brake rotors. In a number of variations, the nitrocarburized vehicle components 2, 2′, 2″ may be pre-heated in air and then immersed in a molten nitrocarburizing salt bath at an elevated, subcritical temperature for a predetermined time. Next, the nitrocarburized vehicle components 2, 2′, 2″ may be removed and directly immersed in an oxidizing salt bath at a moderately lower temperature than the nitrocarburizing salt bath for a second dwell time. Next, the nitrocarburized vehicle components 2, 2′, 2″ may be removed and further cooled to room temperature using water application or slow cooling in air. This compound zone 70 may be an outer portion of ferrous material formed initially through reaction between the iron of the ferrous material and nitrogen and carbon species that may be present in the nitrocarburizing salt bath. Variations of ferritic nitrocarburization can be found in U.S. Patent App. No.: 2013/0000787A1. In other variations, the nitrocarburized vehicle components 2, 2′, 2″ may be ferritically nitrocarburized through a gas nitrocarburization process, a plasma nitrocarburization process, a salt bath nitrocarburization process, a fluidized bed nitrocarburization process, or may be done another way. The compound zone 70 may comprise a iron nitride layer 74 comprising epsilion iron nitride, Fe₃N and a smaller volume of gamma prime iron nitride Fe₄N formed from the nitrocarburizing salt bath, gas process or other process as well as a surface oxide layer 72 may be formed during immersion into the oxidizing salt bath or in another oxidizing atmosphere or environment, wherein the oxide layer 72 may be comprised of oxidized nitrocarburized iron, Fe₃O₄. In a number of variations, the compound zone 70 may have a thickness ranging from 5 to 30 microns, and the oxide layer 72 may have a thickness ranging from 10 to 50% of compound zone. A diffusion layer 77 may be subjacent the iron nitride layer 74 and may be a transition between the iron nitride layer 74 and a portion of the rotational member that may be beyond the reach of ferritic nitrocarburization. The iron nitride layer 74 may have a low coefficient of friction. The concentration of nitrogen in the diffusion layer 77 may be less than the concentration of nitrogen in the iron nitride layer 74 of the compound zone 70 below the oxide layer 72. The oxide layer 72 may have a higher porosity than the iron nitride layer 74. The surface 75 of the iron nitride layer 74 may be substantially free of graphite flakes or may have no exposed graphite flakes.

In a number of variations, the iron nitride layer 74 may be modified.

As the nitrocarburized vehicle components 2, 2′, 2″ and the friction surface 82, 82′, 82″ of the rotational assembly 4, 4′ come into contact during a brake engagement, a complex tribological interface arises that can have significant influence on brake performance. The friction surface 82, 82′, 82″ may be case hardened as a result of the ferritic nitrocarburization and brake performance may be a function of the ferritically nitrocarburized vehicle component 2, 2′, 2′ selected and its resulting interaction with the friction surface 82, 82′, 82″. The ferritically nitrocarburized vehicle component 2, 2′, 2″ may be coated or provided with a vehicle component friction layer 90, 90′, 90″ on the friction surface 82, 82′, 82.″ In a number of variations, the ferritically nitrocarburized vehicle component friction layer 90, 90′, 90″ may be made of asbestos, organic, ceramic, or semi-metallic material or may be another type. In certain variations ceramic compounds, copper fibers, aramid fibres, or other polymeric materials may also be used in the ferritically nitrocarburized vehicle component friction layer 90, 90′, 90″. Semi-metallic brake pads may include steel wool or wire, iron powder, copper, graphite, inorganic fillers, or may include other similar functioning materials. Non-Asbestos organic brake pads may include glass, rubber, carbon, Kevlar, filler materials, high-temperature resins, abrasives, or may include other similar functioning materials. Such high-temperature resins may include polyimides, bezoxazines, bismaleimides, phenols, cyanate esters, or a similar functioning material. Such filler materials may include a barite, a lime, a metal sulfide, steel wool, potassium titanate, or a similar functioning material. Such abrasives may include brass chips, bituminous coal, fiberglass, metal oxide, a mineral, or a similar functioning material. Ceramic brake pads may include ceramic fibers, nonferrous filler materials, bonding agents, metal fillers, or may include other similar functioning materials. The ferritically nitrocarburized vehicle component friction layer 90, 90′, 90″ may be made of aggressive and softer compounds or may fall on a scale all the way to non-aggressive and harder, more durable compounds. The compounds chosen for the friction materials can be changed according to personal tastes, driving styles, operating temperatures, or variation in brake fading.

In one variation, a non-aggressive non-asbestos organic (NAO) lining used in the ferritically nitrocarburized vehicle component friction layer 90, 90′, 90″. In a number of variations, the ferritically nitrocarburized vehicle component friction layer 90, 90′, 90″ may be developed as early as the initial brake 10 engagement. The ferritically nitrocarburized vehicle component friction layer 90, 90′, 90″ may comprise glass, rubber, carbon, Kevlar, filler materials, high-temperature resins, or may include other similar functioning materials.

In a number of variations, a low carbon steel substrate with a composition that meets the requirements identified in Table 1 may be utilized. Vanadium containing alloys above 0.008% are detrimental to ductility and should not be specified.

TABLE 1

| | | | | | | | | | | | All other |
|---|---|---|---|---|---|---|---|---|---|---|---|
| SAE J2329 | Carbon | Manganese | Phosphorus | Sulfur % | | Nickel % | Chromium | Molybdenum | Copper | Tin % | elements |
| Designation | % max | % max | % max | max | Aluminum % | max | % max | % max | % max | max | % max |
| CR2E | 0.10 | 0.50 | 0.035 | 0.035 | 0.020 to | 0.200 | 0.100 | 0.030 | 0.200 | 0.030 | 0.008 |
| modified | | | | | 0.040 | | | | | | |

In a number of variations, FNC components, for example, plates may be stress relieved at a temperature 20 degrees centigrade above the FNC temperature to improve dimensional control. In a number of variations, FNC case depth of 10 to 15 microns may provide higher fatigue strength, corrosion resistance and low coefficient of friction. In a number of variations, porosity of 10-70% of the compound zone depth may be provided. In a number of variations, porosity of 10-50% of the compound zone depth may be provided. In a number of variations, a porosity of about 30% of the compound zone depth may be provided to insure adequate bonding of the friction material. In a number of variations, supplementary zinc rich or polymer coatings may be applied to further enhance corrosion resistance.

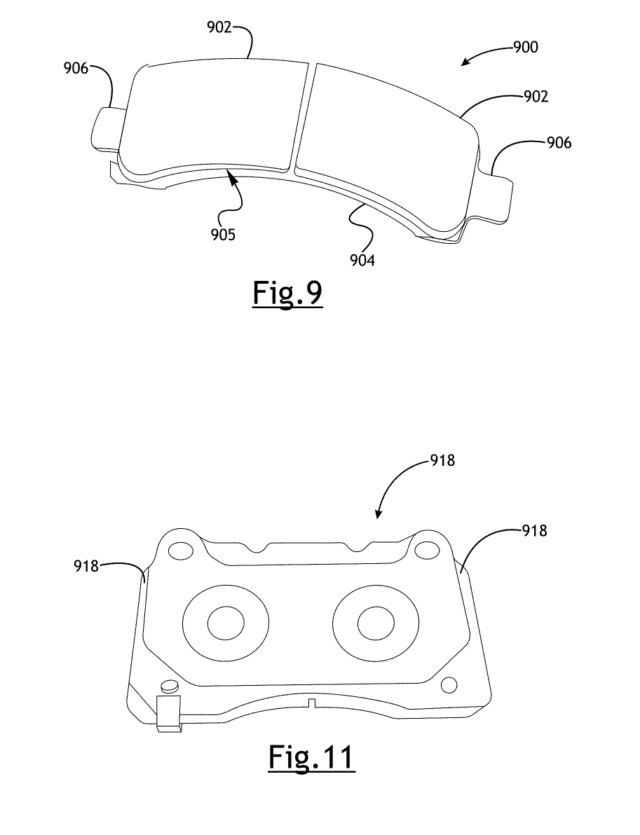

FIG. 9 illustrates a product 900 including a disc brake backplate 904 have two brake pads 902 adhered thereto by an adhesive 905. The backplate 904 includes two outwardly extending abutments 906 that serve the function of reacting brake torque while allowing the pad to slide freely. When the backplate 904 is subject to FNC treatment the abutments 906 remain rust free even after extended use. This is advantageous because a freely sliding pad assembly allows for better transfer of clamp load to the brake rotor, and pad retraction following a brake apply—thus providing better brake feel and reducing brake drag. The improved porosity of the surface of the backplate 904 treated by FNC as set forth herein provides for improved adhesion of the brake pads 902 to the backplate 904.

FIG. 10 illustrates an example brake pad in a sliding caliper bracket, depicting the abutment surfaces in question which FNC will protect from corrosion binding. Corrosion growth in this area will prevent pads from sliding freely, leading to brake drag.

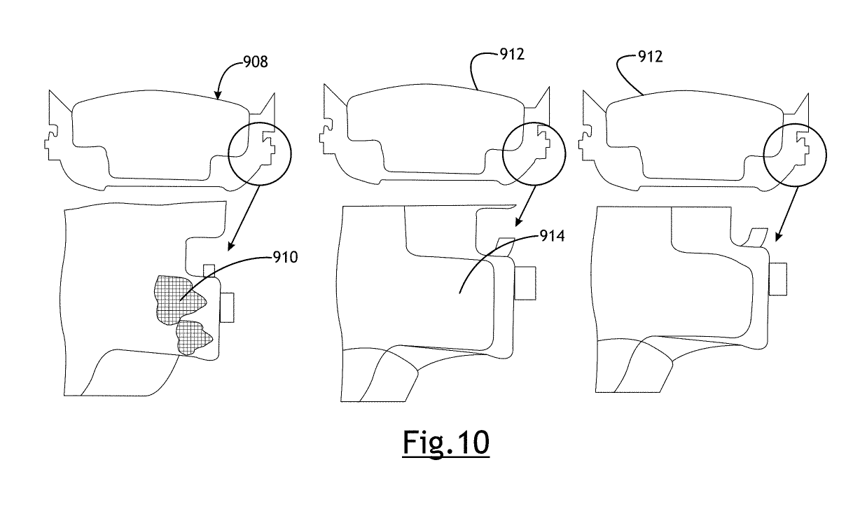

FIG. 11 illustrates an example brake pad from an opposed piston caliper, where the flat edges on the sides of the pads are the abutment surfaces in question which FNC will protect from corrosion binding. Corrosion growth in this area will prevent pads from sliding freely, leading to brake drag.

Numerical data have been presented herein in a range format. It may be understood that this range format is used merely for convenience and brevity and should be interpreted flexibly to include not only the numerical values explicitly recited as the limits of the range, but also to include all the individual numerical values or sub-ranges encompassed within the range as if each numerical value and sub-range is explicitly recited.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a product including a ferritically nitrocarburized vehicle component comprising a compound zone and a friction surface at an outer edge of the compound zone wherein the friction surface is configured for engagement with a corresponding friction material, and wherein the compound zone comprises a nitride layer comprising epsilion iron nitride, Fe₃N and gamma prime iron nitride Fe₄N.

Variation 2 may include a product as set forth in Variation 1 wherein the ferritically nitrocarburized vehicle component comprises a pressure plate for at least one of a brake drum, a disc brake rotor, a drum-in-hat, a clutch assembly, or a combination thereof.

Variation 3 may include a product as set forth in any of Variations 1-2 wherein the ferritically nitrocarburized vehicle component further comprises iron, carbon steel, steel, or stainless steel.

Variation 4 may include a product as set forth in any of Variations 1-3 wherein the nitride layer comprises a surface that comprises the friction surface.

Variation 5 may include a product as set forth in any of Variations 1-4 wherein compound zone further comprises an iron oxide layer overlying the nitride layer that comprises the friction surface.

Variation 6 may include a product as set forth in any of Variations 1-5 wherein the nitride layer has a depth of at least 10 microns.

Variation 7 may include a product as set forth in any of Variations 1-6 wherein the nitride layer has about 10 to about 70% porosity.

Variation 8 may include a product as set forth in any of Variations 1-6 wherein the nitride layer has 0% porosity.

Variation 9 may include a method including providing a vehicle component; ferritically nitrocarburizing the vehicle component to form a compound zone and a friction surface at an outer edge of the compound zone wherein the friction surface is configured for engagement with a corresponding friction material, and wherein the compound zone comprises a nitride layer comprising epsilion iron nitride, Fe₃N and gamma prime iron nitride Fe₄N.

Variation 10 may include a method as set forth in Variation 9 wherein ferritic nitrocarburizing includes a gas nitrocarburizing process, a plasma nitrocarburizing process, a fluidized bed nitrocarburization process, or a salt bath nitrocarburizing process.

Variation 11 may include a method as set forth in any of Variations 9-10 wherein the vehicle component is formed from gray cast iron, steel, carbon steel, or stainless steel.

Variation 12 may include a method as set forth in any of Variations 9-11 wherein the vehicle component comprises a pressure plate for at least one of a brake drum, a disc brake rotor, a drum-in-hat, a clutch assembly, or a combination thereof.

Variation 13 may include a method as set forth in any of Variations 9-12 wherein the nitride layer comprises a surface that comprises the friction surface.

Variation 14 may include a method as set forth in any of Variations 9-13 wherein the ferritically nitrocarburizing the vehicle component step further comprises forming an iron oxide layer in the compound zone overlying the nitride layer wherein the iron oxide layer comprises a surface that comprises the friction surface.

Variation 15 may include a method as set forth in any of Variations 9-14 wherein the nitride layer has a depth of at least 10 microns.

Variation 16 may include a method as set forth in any of Variations 9-15 wherein the nitride layer has about 10 to about 70% porosity.

Variation 17 may include a method as set forth in any of Variations 9-15 wherein the nitride layer has 0% porosity.

Variation 18 may include a method as set forth in any of Variations 9-17 wherein the ferritically nitrocarburizing the vehicle component step comprises heat treatment of the vehicle component in an atmosphere rich in nitrogen and carbon in a mixture.

Variation 19 may include a method as set forth in any of Variations 9-18 wherein the iron oxide layer comprises oxidized nitrocarburized iron of the formula Fe₃O₄.

Variation 20 may include a method as set forth in any of Variations 9-19 wherein the formation of the nitride layer is examined by surface analysis and Scanning Electron Microscopy Energy Dispersive Spectroscopy to verify nitride layer properties.

The above description of select examples of the invention is merely exemplary in nature and, thus, variations or variants thereof are not to be regarded as a departure from the spirit and scope of the invention.

What is claimed is:

1. A product comprising:
a ferritically nitrocarburized vehicle component comprising a compound zone and a friction surface at an outer edge of the compound zone wherein the friction surface is configured for engagement with a corresponding friction material, and wherein the compound zone comprises a nitride layer comprising epsilion iron nitride, Fe₃N and gamma prime iron nitride Fe₄N, wherein the ferritically nitrocarburized vehicle component comprises a pressure plate for at least one of a brake drum, a disc brake rotor, a drum-in-hat, a clutch assembly, or a combination thereof.

2. A product as defined in claim 1 wherein the ferritically nitrocarburized vehicle component further comprises iron, carbon steel, steel, or stainless steel.

3. A product as defined in claim 1 wherein the nitride layer comprises a surface that comprises the friction surface.

4. A product as defined in claim 1 wherein compound zone further comprises an iron oxide layer overlying the nitride layer that comprises the friction surface.

5. A product as defined in claim 1 wherein the nitride layer has a depth of at least 10 microns.

6. A product as defined in claim 1 wherein the nitride layer has about 10 to about 70% porosity.

7. A product as defined in claim 4 wherein the nitride layer has 0% porosity.

8. A product as defined in claim 1 wherein the nitride layer has about 30 to about 50% porosity.

9. A method comprising:
providing a vehicle component;
ferritically nitrocarburizing the vehicle component to form a compound zone and a friction surface at an outer edge of the compound zone wherein the friction surface is configured for engagement with a corresponding friction material, and wherein the compound zone comprises a nitride layer comprising epsilion iron nitride, Fe₃N and gamma prime iron nitride Fe₄N, wherein the nitride layer has a porosity ranging from 10-70 percent, and wherein the ferritically nitrocarburized vehicle component comprises a pressure plate for at least one of a brake drum, a disc brake rotor, a drum-in-hat, a clutch assembly, or a combination thereof.

10. A method as defined in claim 9 wherein ferritic nitrocarburizing includes a gas nitrocarburizing process, a plasma nitrocarburizing process, a fluidized bed nitrocarburization process, or a salt bath nitrocarburizing process.

11. The method as defined in claim 9 wherein the vehicle component is formed from gray cast iron, steel, carbon steel, or stainless steel.

12. The method as defined in claim 9 wherein the vehicle component comprises a pressure plate for at least one of a brake drum, a disc brake rotor, a drum-in-hat, a clutch assembly, or a combination thereof.

13. A method as defined in claim 9 wherein the nitride layer comprises a surface that comprises the friction surface.

14. A method as defined in claim 8 wherein the ferritically nitrocarburizing the vehicle component step further comprises forming an iron oxide layer in the compound zone overlying the nitride layer wherein the iron oxide layer comprises a surface that comprises the friction surface.

15. A method as defined in claim 9 wherein the nitride layer has a depth of at least 10 microns.

16. A method as defined in claim 9 wherein the nitride layer has about 30 to about 50% porosity.

17. A method as defined in claim 9 wherein the nitride layer has about 30% porosity.

18. A method as defined in claim 9 wherein the ferritically nitrocarburizing the vehicle component step comprises heat treatment of the vehicle component in an atmosphere rich in nitrogen and carbon in a mixture.

19. A method as defined in claim 9 wherein the iron oxide layer comprises oxidized nitrocarburized iron of the formula Fe₃O₄.

20. A method as defined in claim 9 wherein the formation of the nitride layer is examined by surface analysis and Scanning Electron Microscopy Energy Dispersive Spectroscopy to verify nitride layer properties.
